(19) United States
(12) Patent Application Publication
(10) Pub. No.: US 2003/0061187 A1
(43) Pub. Date: Mar. 27, 2003

(54) Learning support apparatus and method

(75) Inventors: Mika Fukui, Tokyo (JP); Sougo Tsuboi, Kanagawa-ken (JP); Hideo Umeki, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/254,940

(22) Filed: Sep. 26, 2002

(30) Foreign Application Priority Data
Sep. 26, 2001 (JP) 2001-292865

(51) Int. Cl. G06N 5/00; G06F 17/00

(52) U.S. Cl. 706/45

(57) ABSTRACT

A teaching material memory stores teaching material consisting of multimedia data. A teaching material presentation unit presents the teaching material. An operation unit inputs operation information from a learner for the teaching material presented. A condition information input unit acquires condition information representing the learner's condition. A learning condition decision unit decides a learning condition of the learner based on the condition information, presentation situation of the teaching material, and the operation information. A learning condition memory correspondingly stores the learning condition and the presentation situation of the teaching material as time series information. A presentation method decision unit determines a presentation method of the teaching material and the time series information based on the learning condition. A learning condition presentation unit presents the time series information to the learner based on the presentation method.

### CROSS-REFERENCE TO RELATED APPLICATIONS

This application is based upon and claims the benefit of priority from the prior Japanese Patent Application PH2002-292865, filed on Sep. 26, 2001, the entire contents of which are incorporated herein by reference.

### FIELD OF THE INVENTION

The present invention relates to a learning support apparatus and a method for supporting a learner who performs independent study using teaching materials provided through a network.

### BACKGROUND OF THE INVENTION

In recent years, by the spread of inexpensive computers and the Internet, as assistance means of the group study by a teacher and a plurality of students in a classroom, correspondence courses (so-called e-Learning) using a computer are becoming more popular. There are no restrictions of time and place in such correspondence courses. Therefore, anyone can perform independent study in a home or an office. For example, there is the correspondence course aiming at the reeducation for the middle-aged and the elderly, lifelong education such as language study, and home study for children. For this reason, many teaching materials for self-teaching are created.

However, in such a correspondence course, a learning style by self-teaching is mainly applicable. As a result, there is a problem that continuation of learning is difficult. For example, the student who graduates without retiring is estimated as 20 to 30 percent of all students in the communication division of a university. In order to solve this problem, production of teaching materials which is not boring for the learner, maintenance of the support system of an adviser and a secretariat, are performed. However, time and energy are necessary for a learner to receive support. Therefore, there are many learners who cannot continually take lectures and finally retire.

As a problem of a learning style of self-teaching, even if a learner begins with volition, it often happens that the learner cannot understand on the way, or the learner gets bored. Moreover, when a learner falls asleep, the learner cannot understood which teaching material he/she should resume from. It is possible to test the degree of achievement finely for the learner and to investigate where he/she should resume. However, it is hard to accept this method for a busy learner.

As technology relevant to the above, U.S. Pat. Nos. 2,546,415, 2,912,376, 2,936,943, and Japanese Patent disclosure (Kokai) PH5-96971, are cited. For example, in order to prevent a nap at the time of driving of a car, the method of detecting a nap is disclosed by using analysis of the image of the portion of the eye of a driver, analysis of the posture of a driver, and measurement of skin potential of a driver. Furthermore, if the nap of a driver is detected, the method for calling attention of a driver is also disclosed by a buzzer or vibration of a chair. However, in the case of the learner of the correspondence course, even if the learner falls asleep, it is not a safety problem. Moreover, for a learner, even if attention is called on that spot, the learner cannot concentrate on teaching materials immediately. Rather, the learner can easily concentrate to the lecture in the case that he/she resumes after a short break.

Furthermore, in the correspondence course, it is hard to find a partner who shares the trouble under study, such as delay of progress. In group study in a classroom, a learner can grasp other surrounding learners' situation to some extent. Therefore, a learner gets to know that another learner also cannot understand the lecture, and the learner can feel easy. Furthermore, a learner is encouraged by the friend who is doing his best, or they also help each other. However, at the correspondence course, a learner cannot see other learners who currently study with the same teaching materials, and there are few opportunities of communication between them. In order to solve such a problem, there is also a correspondence course site with a system which supports communication between learners by the electronic bulletin board (billboard). However, when study volition has fallen, there are few learners who reveal a trouble with a billboard positively. Rather, it is thought that there are many isolated students, without starting action from oneself.

On the other hand, for other learners, there is no means to get to know existence of the learner on whom study volition has fallen. But it is also a problem to tell all other students about the existence of the learner on whom study volition has fallen. Because the pride of the learner on whom study volition has fallen is damaged. Moreover, when there are too many learners who are in trouble, mutual help of the learners is difficult. After all, it is best that a certain learner's learning condition is presented to another learner who is suitable to be known. However, in the prior art, a decision of a suitable learner is difficult.

Thus, in the learning support apparatus of the prior art, when a learner interrupts learning on the way, it is unclear how far the learner understands and where he/she should resume from. Therefore, continuation of learning by the correspondence course was difficult for the learner. Moreover, since other learners' learning situation was not in sight, it is difficult to perform communication to encourage the learner for whom study volition has fallen.

### SUMMARY OF THE INVENTION

It is an object of the present invention is to provide a learning support apparatus and a method for presenting a learner's learning condition in time series, and for making the learner resume learning from the teaching material at the time the learner's concentration fell.

According to the present invention, there is provided a learning support apparatus, comprising: a teaching material memory configured to store a teaching material consisting of multimedia data; a teaching material presentation unit configured to present the teaching material stored in the teaching material memory to a learner; an operation unit configured to input operation information from the learner for the teaching material presented by said teaching material presentation unit; a condition information input unit configured to acquire condition information representing the learner's condition; a learning condition decision unit configured to decide a learning condition of the learner based on the condition information acquired by said condition information input unit, presentation situation of the teaching material presented by said teaching material presentation unit, and the operation information inputted by said operation unit; a learning condition memory configured to correspondingly store the learning condition decided by said learning condition decision unit and the presentation situation of the teaching material as time series information; a presentation method decision unit configured to determine a presentation method of the teaching material stored in said teaching material memory and the time series information stored in said learning condition memory based on the learning condition; and a learning condition presentation unit configured to present the time series information stored in said learning condition memory to the learner based on the presentation method determined by said presentation method decision unit.

Further in accordance with the present invention, there is also provided a method for supporting learning, comprising: storing a teaching material consisting of multimedia data in a teaching material memory; presenting the teaching material stored in the teaching material memory to a learner; inputting operation information from the learner for the teaching material presented; acquiring condition information representing the learner's condition; deciding a learning condition of the learner based on the condition information acquired, presentation situation of the teaching material presented, and the operation information inputted; correspondingly storing the learning condition decided and the presentation situation of the teaching material as time series information in a learning condition memory; determining a presentation method of the teaching material stored in the teaching material memory and the time series information stored in the learning condition memory based on the learning condition; and presenting the time series information stored in the learning condition memory to the learner based on the presentation method determined.

Further in accordance with the present invention, there is also provided a computer program product, comprising: a computer readable program code embodied in said product for causing a computer to support learning, said computer readable program code having: a first program code to store a teaching material consisting of multimedia data in a teaching material memory; a second program code to present the teaching material stored in the teaching material memory to a learner; a third program code to input operation information from the learner for the teaching material presented; a fourth program code to acquire condition information representing the learner's condition; a fifth program code to decide a learning condition of the learner based on the condition information acquired, presentation situation of the teaching material presented, and the operation information inputted; a sixth program code to correspondingly store the learning condition decided and the presentation situation of the teaching material as time series information in a learning condition memory; a seventh program code to determine a presentation method of the teaching material stored in the teaching material memory and the time series information stored in the learning condition memory based on the learning condition; and an eighth program code to present the time series information stored in the learning condition memory to the learner based on the presentation method determined.

### BRIEF DESCRIPTION OF THE DRAWINGS

FIG. 1 is a block diagram of a learning support apparatus according to the first embodiment of the present invention.

FIG. 2 is a flow chart of processing of the learning support method according to the first embodiment of the present invention.

FIG. 3 is a schematic diagram of learning condition of the learner stored in a learning condition memory according to the first embodiment of the present invention.

FIG. 4 is a schematic diagram of presentation method decision rule according to the first embodiment of the present invention.

FIG. 5 is a schematic diagram of the learning condition presented according to the first embodiment of the present invention.

FIG. 6 is a schematic diagram of teaching material presented and the past learning condition according to the first embodiment of the present invention.

FIG. 7 is a block diagram of the learning support apparatus according to a second embodiment of the present invention.

FIG. 8 is a schematic diagram of an interface to move from the presented teaching material and the past learning condition to a billboard according to the second embodiment of the present invention.

FIG. 9 is a schematic diagram of a perusal screen of the billboard relevant to the teaching materials according to the second embodiment of the present invention.

FIG. 10 is a schematic diagram of a window screen for inputting a reply to the message of a billboard according to the second embodiment of the present invention.

FIG. 11 is a schematic diagram of an interface for calling a friend from a screen of the learning condition according to the second embodiment of the present invention.

FIG. 12 is a schematic diagram of the learning condition of learners who have learned with the same teaching materials in the past according to the second embodiment of the present invention.

FIG. 13 is another schematic diagram of the learning condition of learners who have learned with the same teaching materials in the past according to the second embodiment of the present invention.

FIG. 14 is a schematic diagram of reply relation of messages among learners according to the second embodiment of the present invention.

FIG. 15 is a schematic diagram of a calculation result of personal relationship values of the learners according to the second embodiment of the present invention.

FIG. 16 is a schematic diagram of an expression dictionary for computing the personal relationship value according to the second embodiment of the present invention.

FIG. 17 is a schematic diagram of the personal relationship value calculated using the expression dictionary according to the second embodiment of the present invention.

FIG. 18 is a schematic diagram of a screen where a friend's learning condition is always displayed according to the second embodiment of the present invention.

### DETAILED DESCRIPTION OF THE EMBODIMENT

Various embodiments of the present invention will be explained by referring to the drawings. Hereafter, the first embodiment of the present invention is explained.

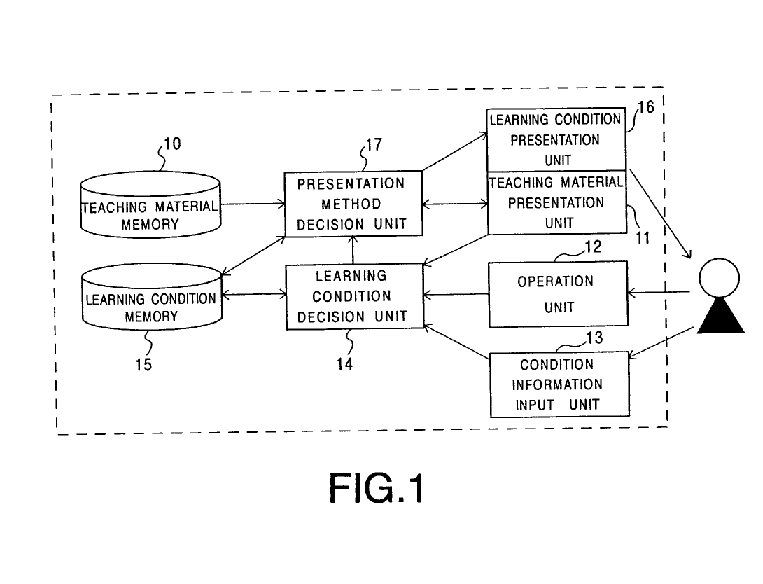

FIG. 1 is a block diagram of a learning support apparatus according to the first embodiment of the present invention. In a teaching material memory 10, teaching materials which consist of multimedia data, such as voice, image, and text data prepared beforehand, are stored. The teaching material stored in the teaching material memory 10 is presented to a learner through a teaching material presentation unit 11 such as a display and a speaker. The learner selects the teaching materials to be presented and inputs an answer to a problem through an operation unit 12 such as a keyboard and a mouse. A condition information input unit 13 is, for example, a camera monitoring a learner's learning condition, a microphone gathering speech information, or an apparatus for monitoring living body information such as a learner's skin potential. A learning condition decision unit 14 decides the learning condition of the learner's awakening situation based on condition information such as the image, voice and living body information acquired from the condition information input unit 13. A learning condition memory 15 correspondingly stores the learning condition decided by the learning condition decision unit 14 and presentation situation of the teaching materials presented by the teaching material presentation unit 11 as time series information. A learning condition presentation unit 16 presents the learning condition stored in the learning condition memory 15 with the presentation situation of teaching materials presented by the teaching material presentation unit 11. A presentation method decision unit 17 determines a method for presenting the teaching material stored in the teaching material memory 10 through the teaching material presentation unit 11 based on the learner's operation information inputted from the operation unit 12 and the learning condition stored in the learning condition memory 15. Moreover, the presentation method decision unit 17 determines a method for presenting the learning condition stored in the learning condition memory 15 through the learning condition presentation unit 16.

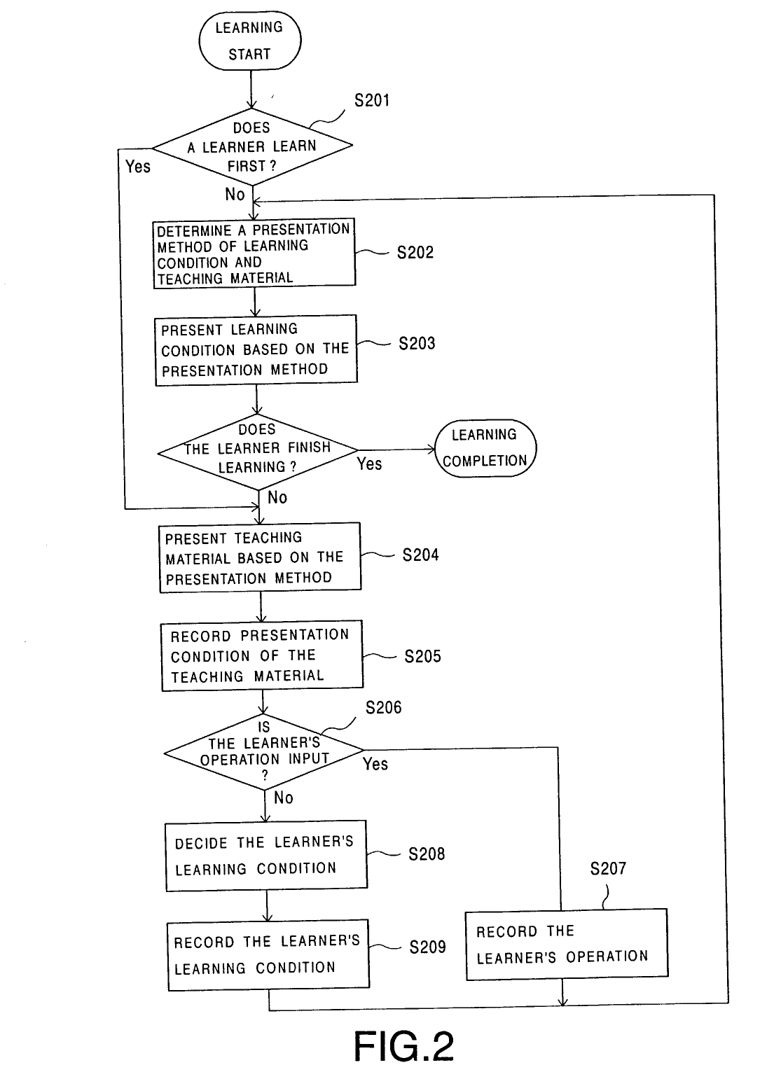

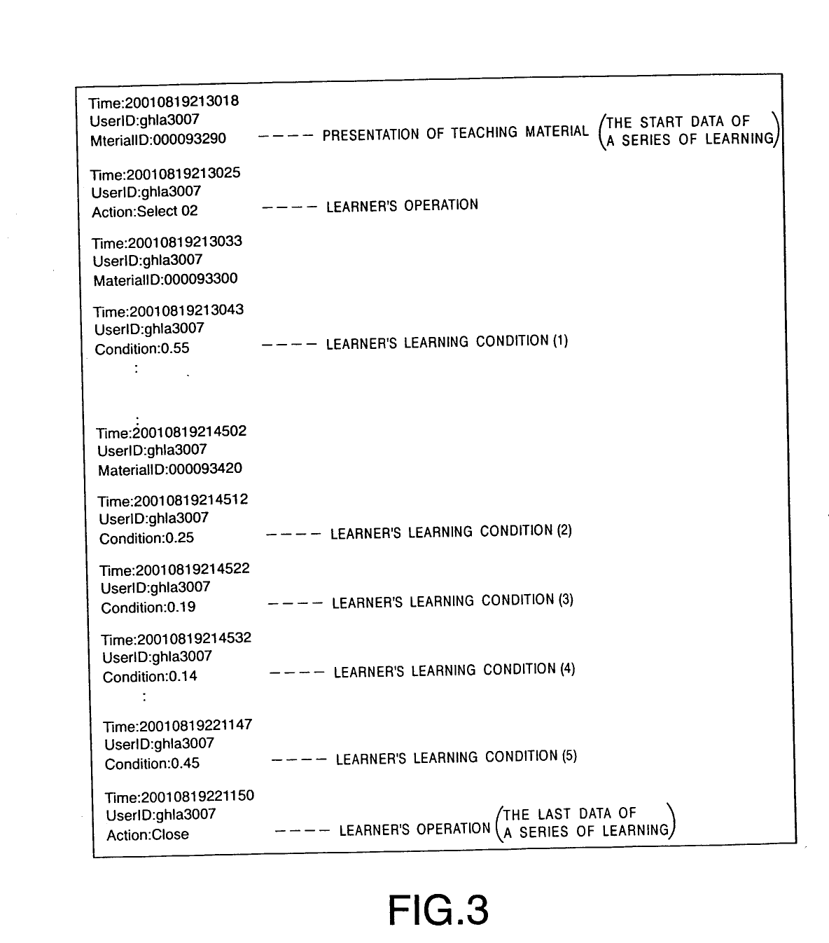

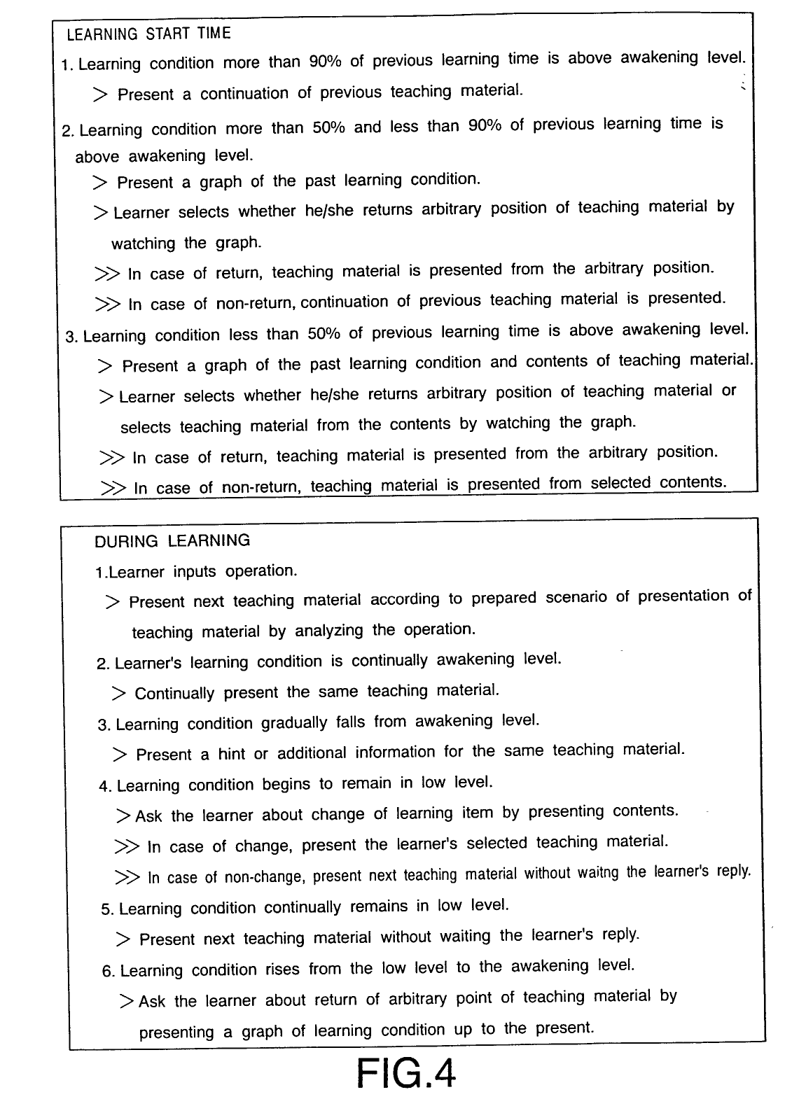

Below, processing of the learning support method of the first embodiment of the present invention is explained. FIG. 2 is a flow chart outline of the processing. When a learner starts learning by operation from the operation unit 12, the presentation method decision unit 17 checks the past learning condition of the learner stored in the learning condition memory 15, and decides whether the learner studies first (Step S201). Here, as shown in FIG. 3, in the learning condition memory 15, a learner ID, time information, operation information, teaching material ID of the presented teaching material, and the learning condition of the learner, are stored in time series. If the learner's record is not stored at all, the learner's study is decided to be first. In the case of the first study, the teaching material presentation unit 11 presents the first teaching material to the learner according to a presentation sequence stored in the teaching material memory 10 (Step S204). In the case of non-first study, the presentation method decision unit 17 refers to the past learning condition of the learner stored in the learning condition memory 15, and determines a method for presenting the teaching material and the learning condition based on a rule of learning start time shown in FIG. 4.

Next, processing of the presentation method decision unit 17 is explained by using the learning condition information of FIG. 3. First, from the learning condition memory 15, a series of data, having a recorded time, a recorded user ID the same as the learner, and a recorded date nearest to the present date, are extracted. From this data, data of earliest time (start data of a series of learning), data of latest time (last data of a series of learning), and learning condition data (each line with “Condition”), are extracted. Then, the sum of time (concentration time) during which “Condition” is above a predetermined value (a lower limit of awakening level, for example, 0.2) is calculated, and the sum of time (recess time) during which “Condition” is not above a predetermined value is calculated. For example, in the case of calculating at estimate, in a period of state of Condition 1 up to state of Condition 2, assume that the period is the state of Condition 1. In FIG. 3, “Condition” is 0.25 at learning condition (2), “Condition” is 0.19 at learning condition (3), and the period is 10 seconds. These 10 seconds are added to the sum of concentration time which “Condition” is above 0.2. On the other hand, 10 seconds of a period between learning condition (3) and learning condition (4) are added to the sum of recess time which “Condition” is not above 0.2. In a period from a learning start time to a time of first condition data, learning condition of the first condition data is regarded to continue. Therefore, in FIG. 3, in 25 seconds from the learning start time (presentation of teaching material) to the learning condition (1), “Condition” is 0.55. Moreover, in 3 seconds from the learning condition (5) to a learning close time (learner's operation), “Condition” is 0.45.

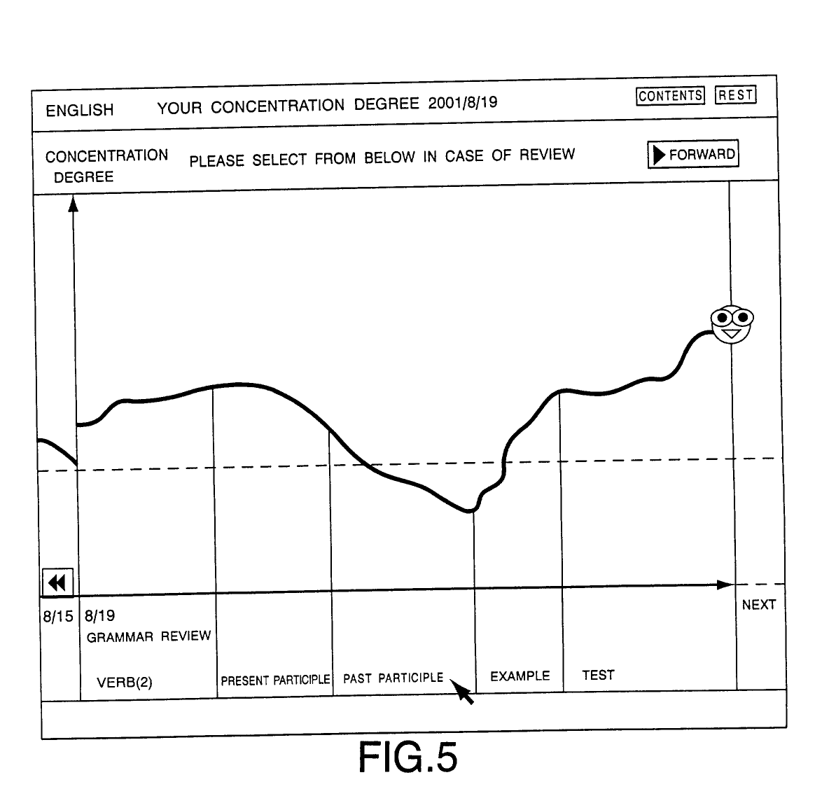

After the concentration time and the recess time are calculated by this method, a value of “(concentration time/(concentration time+recess time))×100” is calculated. If this value is more than 90%, a rule 1 of learning start time in FIG. 4 is used. If this value is more than 50% and less than 90%, a rule 2 of learning start time in FIG. 4 is used. If this value is less than 50%, a rule 3 of learning start time in FIG. 4 is used. In the case of the rule 1 or the learner's selecting [FORWARD] without selecting the past learning item, the next teaching material to be presented is determined according to a setup stored in the teaching material memory 10 and the past learning condition. Moreover, in the case of the rule 2 or rule 3, the past learning condition stored is presented to the learner through the learning condition presentation unit 16 (Step S203). For example, as shown in FIG. 5, the learning condition is displayed as a graph in time series. In this case, presentation time of the teaching material is represented as a horizontal axis and concentration degree of the learner is represented as a vertical axis. This graph may be displayed by curvilinear approximation. In FIG. 5, item name of the presented teaching materials is displayed along a time-axis. Here, when a learner specifies an arbitrary item name, the teaching materials of the specified item name are read from the teaching material memory 10 and presented through the teaching materials presentation unit 11 (Step S204). Therefore, the learner can resume learning.

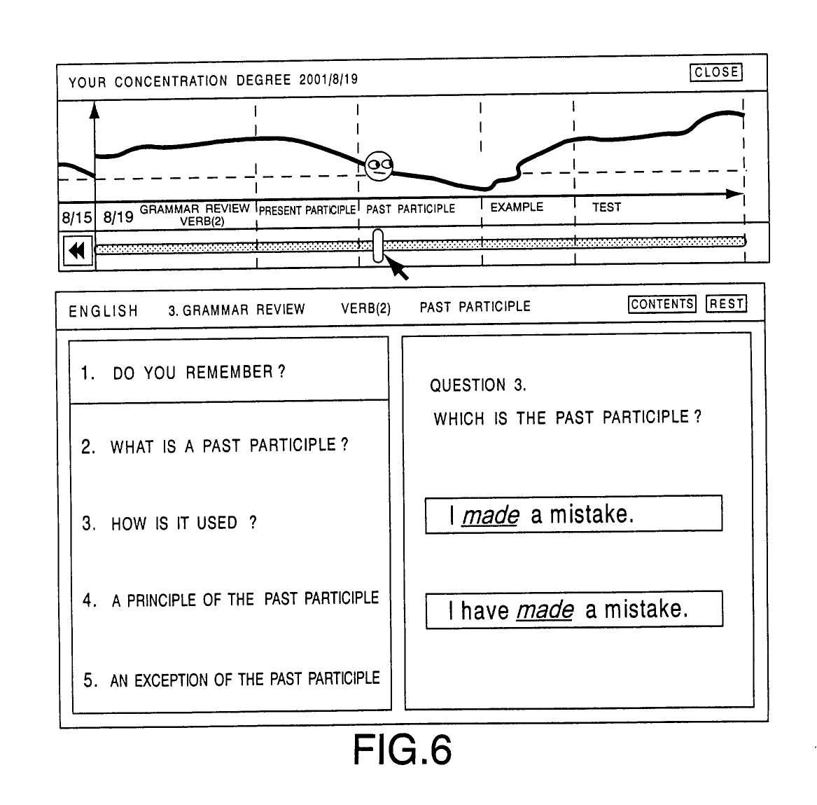

When the learner performs an operation beforehand set in the teaching materials within a fixed time, predetermined teaching materials are presented in order through the teaching materials presentation unit 11 according to the setup of the teaching materials. For example, assume that the teaching material presentation unit 11 presents a problem as shown in FIG. 6. In this case, if the learner selects a correct answer through the operation unit 12, the next problem is presented. Moreover, if the learner selects an incorrect answer, a page of description is presented. According to such setup, the presentation method decision unit 17 determines the teaching materials to be presented. Moreover, as shown in FIG. 6, the teaching material presentation unit 11 and the learning condition presentation unit 16 may simultaneously present the teaching materials and the past learning condition on the same screen. In FIG. 6, the past learning condition is presented in the upper window and corresponding teaching materials are presented in the lower window. Through the operation unit 12, the learner adjusts the contents of presentation of teaching materials by moving a slider of the window in FIG. 6. The learner can confirm the contents by operating the slider and can resume study by selecting an arbitrary position within the teaching material. After presenting the teaching materials, the presented teaching material and the time are stored in the learning condition memory 15 in the format of FIG. 3 (Step S205). The learner advances learning according to the presented teaching materials. For example, the learner selects one of the items presented on the lower window in FIG. 6, or inputs a reply through the operation unit 12 using a keyboard or a microphone. (Step S206). The contents of learner's operation and the time of operation are also stored in the learning condition memory 15 as a part of the learning condition as shown in FIG. 3. (Step S207).

By the way, if the learner does not perform the next operation within a predetermined time, the learning condition decision unit 14 executes decision processing of the learner's learning condition. As a method for deciding the learning condition in the learning condition decision unit 14, for example, the learner's image information inputted from a camera as the condition information input unit 13 is analyzed. Then, the awakening degree is calculated based on taking a seat, leaving a seat, direction of a face, a gazing point on a screen, the number of times of a blink, a length of the time during which the eyes close, movement of the head such as a nod, and the facial expression. Moreover, the awakening degree may be calculated using living body information, such as pulse, skin potential, skin temperature, and blood sugar level. Furthermore, frequency of breathing may be calculated using the sound of breathing inputted from a microphone. The learner's learning condition (For example, the awakening degree is regarded as the concentration degree.) is calculated as values from zero to 1.0. Otherwise, if time from a presentation timing of teaching materials to an input timing of the learner's operation exceeds a fixed time, it may be decided that the concentration degree fell. As shown in FIG. 3, the learner's learning condition and the time are stored in the learning condition memory 15 as a part of the learning condition (Step S209). If the learner's operation from the operation unit 12 and the learning condition are recorded, the presentation method decision unit 17 determines a presentation method of next teaching material (Step S202). In this case, the presentation method is determined using the rule during learning as shown in FIG. 3. First, when a learner performs operation beforehand set in the teaching materials within a fixed time, the teaching material to be presented next is determined using the setup by the rule 1. For example, in the teaching materials shown in FIG. 6, if the learner selects a correct answer, the next problem stored in the teaching material memory 10 is presented. Moreover, if the learner selects an incorrect answer, an explanation page stored in the teaching material memory 10 is presented. The presentation method decision unit 17 determines the teaching materials to be presented according to this setup.

On the other hand, when the learner does not operate within a fixed time, the presentation method decision unit 17 determines the following presentation contents according to progress of the learning condition. Here, as shown in FIG. 4, the presentation contents are determined using the presentation method decision rule during learning. For example, in the teaching materials of FIG. 6, even if the leaner does not reply to a question for 10 seconds, if a value of the learner's learning condition acquired from the learning condition decision unit 14 is continually good, the same page is succeedingly presented according to the rule 2. Moreover, if the value of learning condition falls from a high level, a hint or a picture which attracts the learner's eye is presented according to the rule 3. If the value of the learning condition remains at a low level, a table of contents of teaching materials are presented and it is inquired of the learner about change of learning item according to a rule 4. Furthermore, if the value of the learning condition remains at a low level and the learner selects non-change of learning item, the next problem is presented without waiting for the learner's reply according to the rule 5. If the value of the learning condition goes up from the low level to the awakening level, the graph of the learning condition up to the present is presented as shown in FIGS. 5 and 6. And it enables the learner to select whether learning progress is returned to an arbitrary teaching material position (teaching materials learned in the past) and the learner resumes from the arbitrary teaching material position.

As explained above, in the first embodiment of the present invention, the learner can check his/her learning condition at suitable timing. Therefore, the learning progress can be return to the past teaching materials necessary for the learner after interruption of the learning. As a result, the learner can easily resume the learning. For example, even if the learner missed the lecture because of a nap during the presentation of the teaching materials such as video or voice, the learner can have supplementary lessons for the missed portion afterwards. Thereby, the learner can continue learning without giving up on the way in self-teaching style such as a correspondence course.

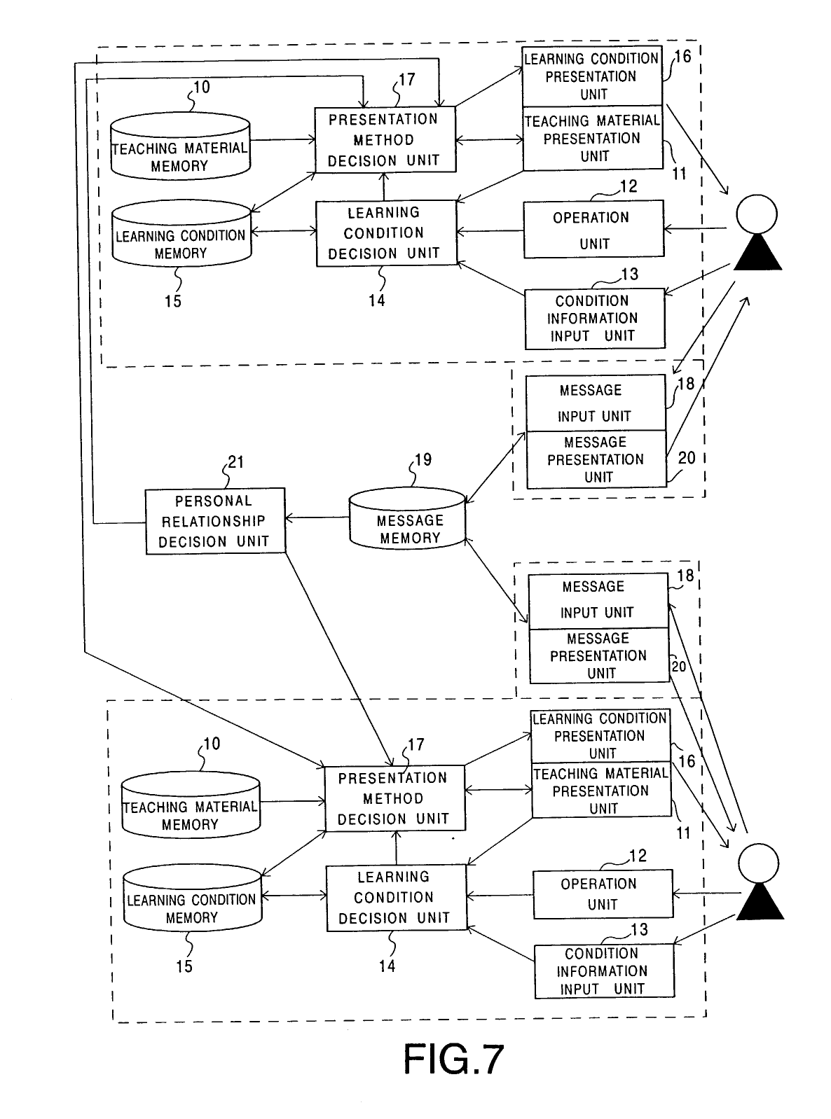

Next, the second embodiment of the present invention is explained by referring to the drawing. FIG. 7 is a block diagram of the learning support apparatus according to the second embodiment of the present invention. The learning support apparatus of each learner includes the same component of the apparatus of the first embodiment shown in FIG. 1. Briefly, the learner learns using the teaching material presentation unit 11 and the operation unit 12. In FIG. 7, as for the same unit included in the apparatus of FIG. 1, the same reference numbers are assigned. In FIG. 7, the learning support apparatus is respectively prepared for each learner. However, all learners may commonly utilize one learning support apparatus.

In the learning support apparatus of the second embodiment, in order to communicate among learners, the following components are included in addition to the components of the first embodiment. A message input unit 18 inputs message data containing text, voice, or picture. Moreover, the message input unit 18 inputs a destination (a learner name of a learner or a group name of learners who can read a message). A message memory 19 stores the message with the destination inputted from the message input unit 18. A message stored in the message memory 19 is presented to a message presentation unit 20 of a learner or members of a group contained in the destination of the message. A personal relationship decision unit 21 analyzes the destination information or the message data itself stored in the message memory 19, and determines the personal relationship between learners. The presentation method decision unit 17 specifies another learner closely related to the learner by referring to the personal relationship decided by the personal relationship decision unit 21, and reads another learner's learning condition from the learning condition memory 15. And the presentation method decision unit 17 decides whether another learner's learning condition is presented, and determines the presentation method in case of presenting.

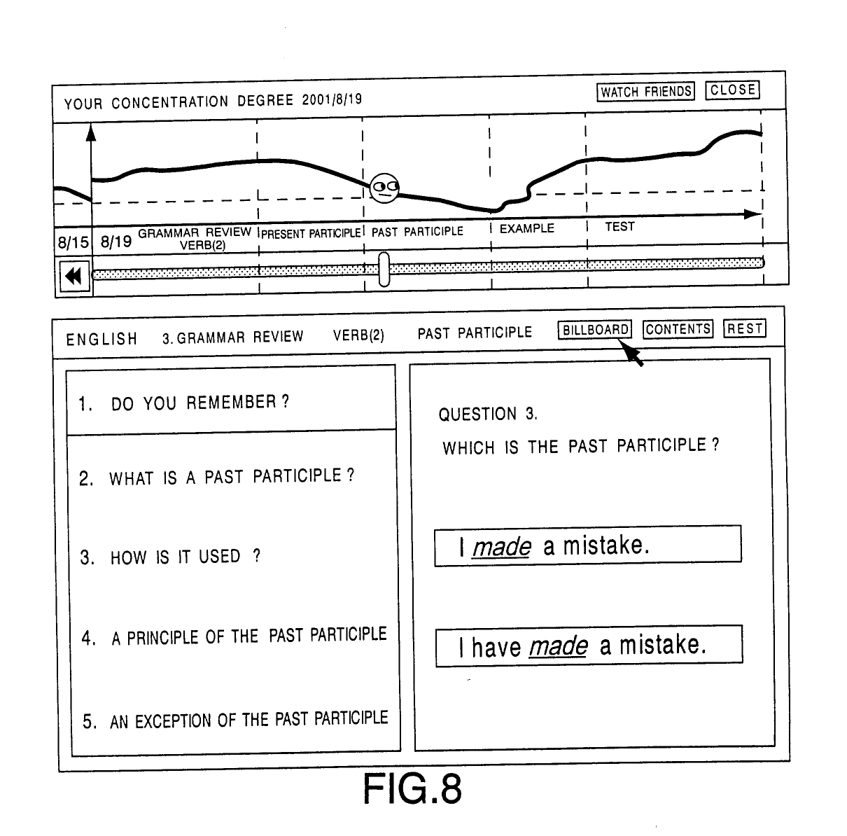

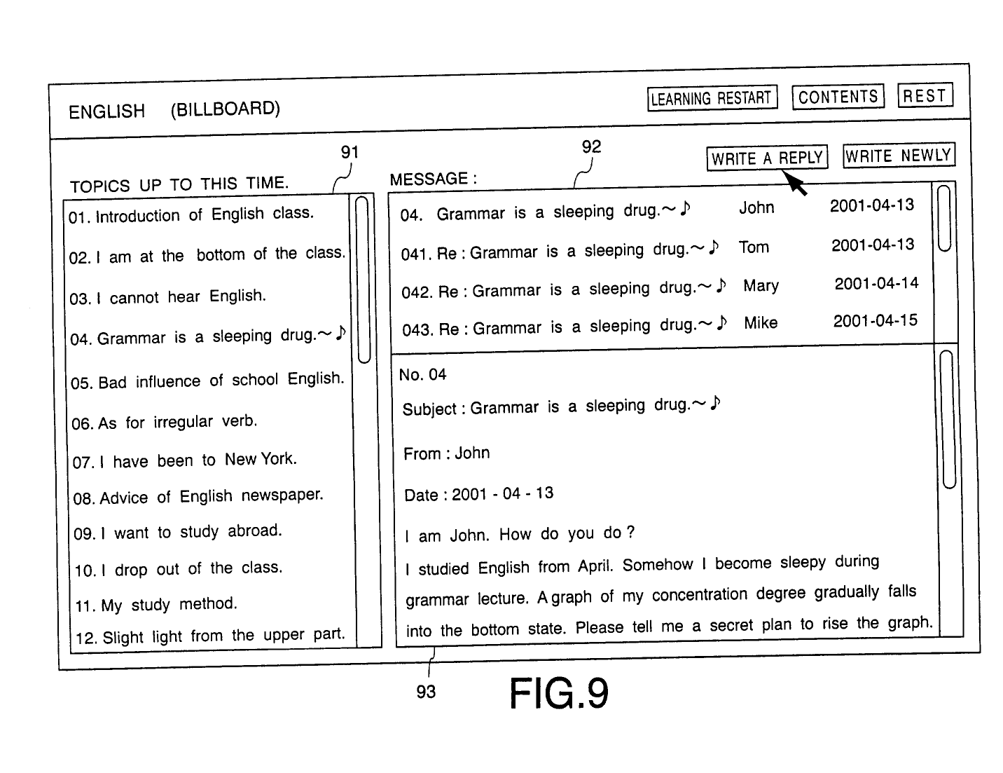

Below, the processing of the learning support method according to the second embodiment of the present invention is explained. Here, a plurality of learners study in self teaching form using the same teaching materials in the same way as in the first embodiment. Moreover, each leaner who learns the same teaching material has a means to exchange messages. For example, it is assumed that the learner selects [BILLBOARD] on a screen of the teaching material presentation unit 11 in FIG. 8. In this case, as shown in FIG. 9, a perusal screen of the bulletin board (billboard) relevant to the teaching materials is displayed on the message presentation unit 20. In the message presentation unit 20, a list 91 of topics contributed to the billboard up to now is displayed based on the data stored in the message memory 19 in order of a time which the topic was created. When the learner selects one of the topics, a list 92 of messages contributed to the selected topic is displayed. In the list 92, a message (first message) which created the selected topic, a reply message (second message) contributed to the selected topic, and another reply message (third message) contributed to the second message and so on, are displayed in order of a time which the message is contributed. A text 93 of the selected message is displayed on the bottom of the list 92.

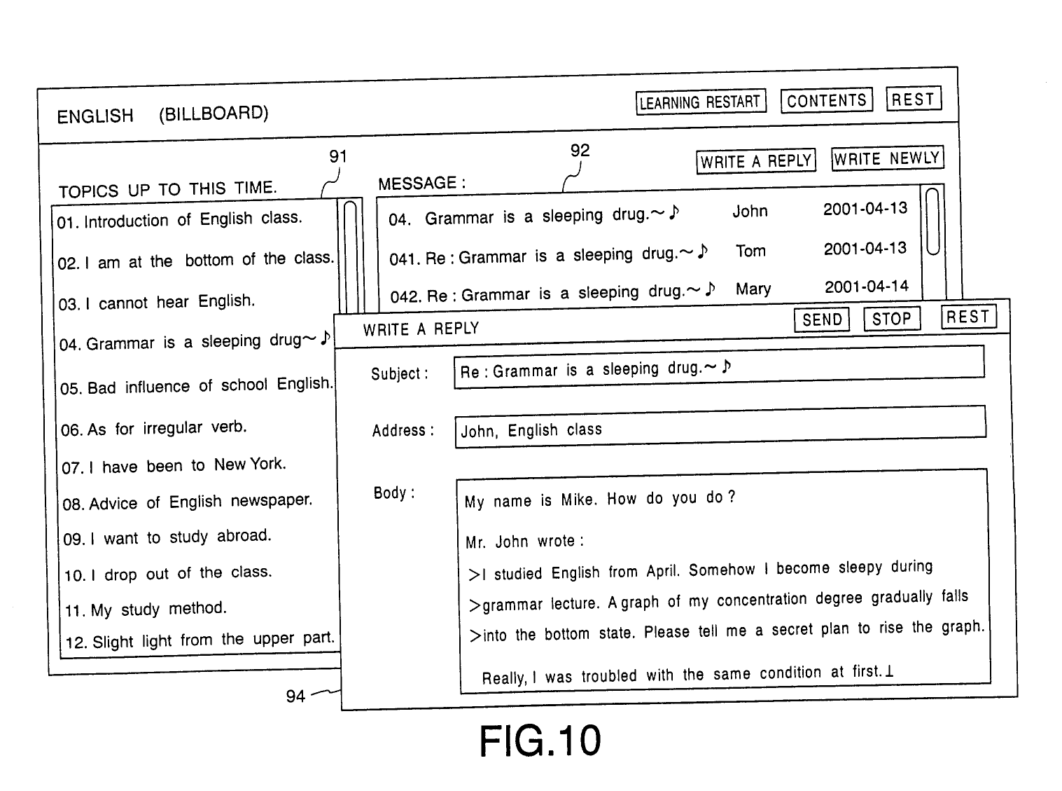

When a learner selects a button [WRITE A REPLY], a window screen to input a reply is presented for the selected message as shown in FIG. 10. The learner can write a reply to the message through the message input unit 18 using this window screen.

Moreover, when a learner selects a button [WRITE NEWLY], the learner can contribute a message about a new topic. In the example of FIG. 10, a reply to the message may be sent to the billboard and sent to the contributor of the destination. As for the contributed message, a topic No., a message No., a subject, an author name, a text, date and time of creation, and a destination, are stored in the message memory 19. In the case of a reply, a message No. and a subject No. of the message contributed by the destination, are stored in the message memory 19.

Moreover, in the case of contributing a new topic, topic data such as a subject No., the first message No. of the topic, a subject, an author name, and the date and time of contribution, are recorded.

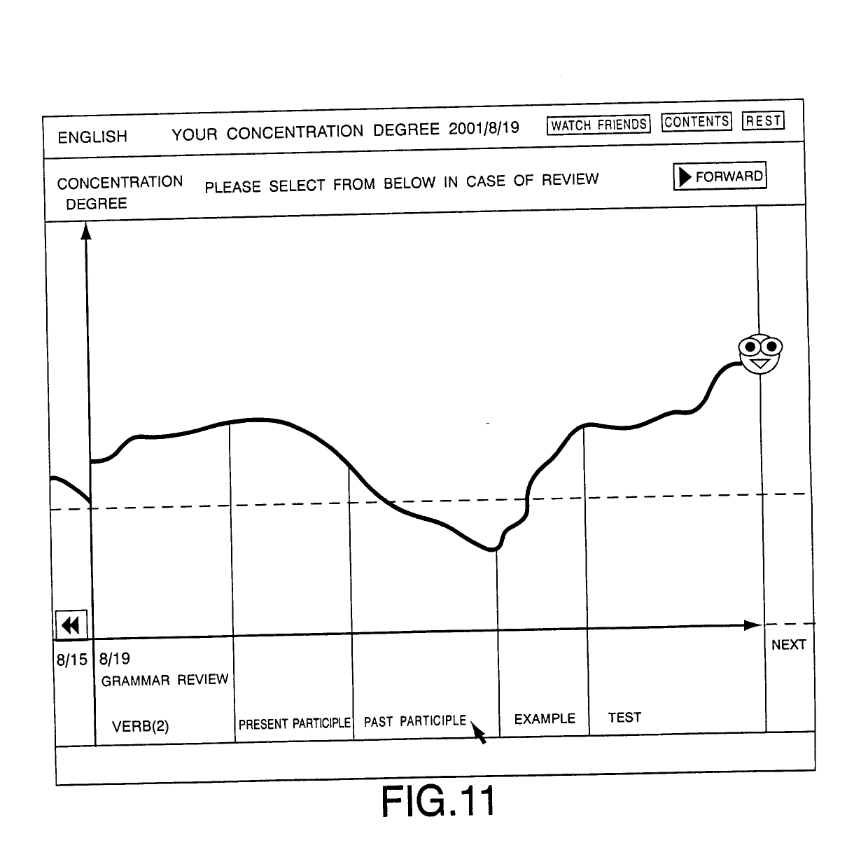

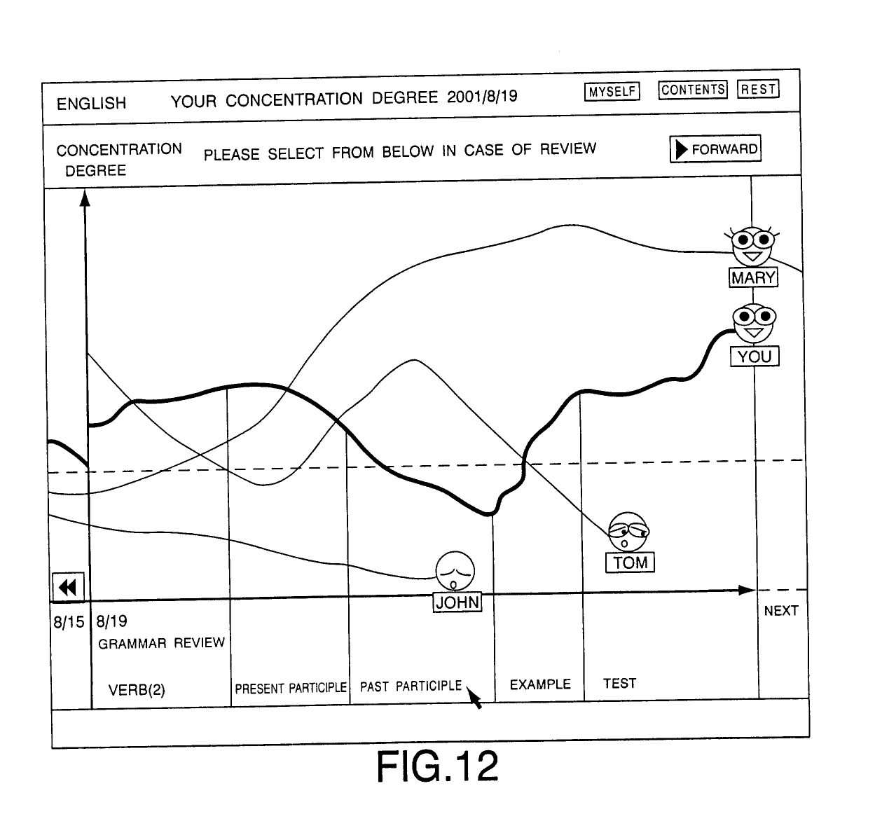

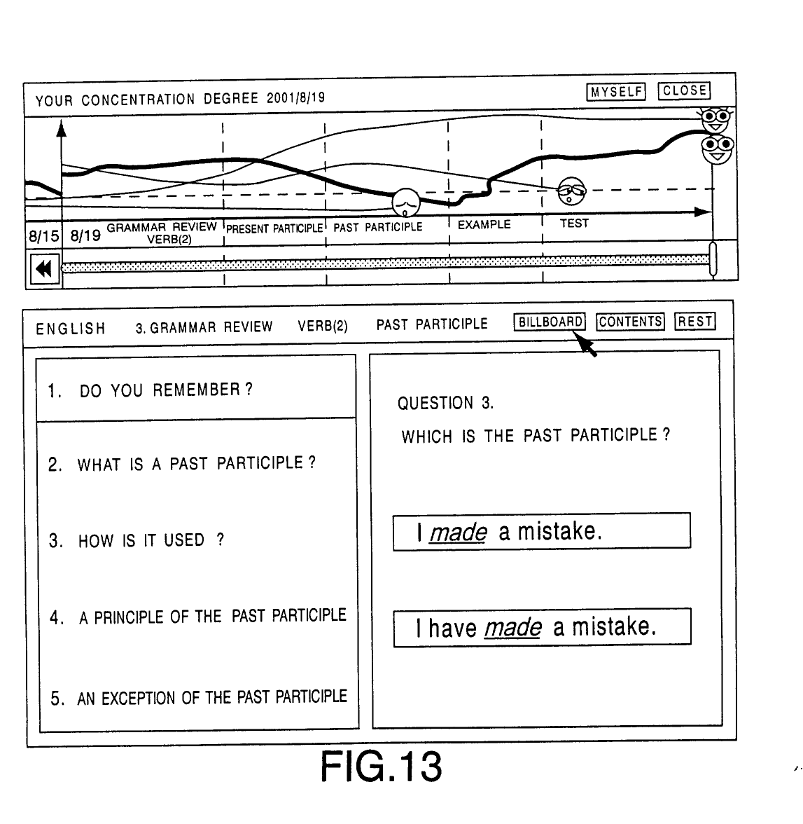

Moreover, in the case of learning start, assume that a learner selects [WATCH FRIENDS] on a screen of the teaching materials of FIG. 8 or the learning condition of FIG. 11. In this case, another learner who studied with the same teaching material in the past is specified from other learners of high personal relationship, and the learning condition of another learner is simultaneously displayed in a screen as shown in FIGS. 12 and 13. Thereby, the learner is encouraged by watching another learner's learning condition, or by knowing the existence and status of other learners. For example, by selecting a presented face of another learner, the learner can easily send a message to another learner.

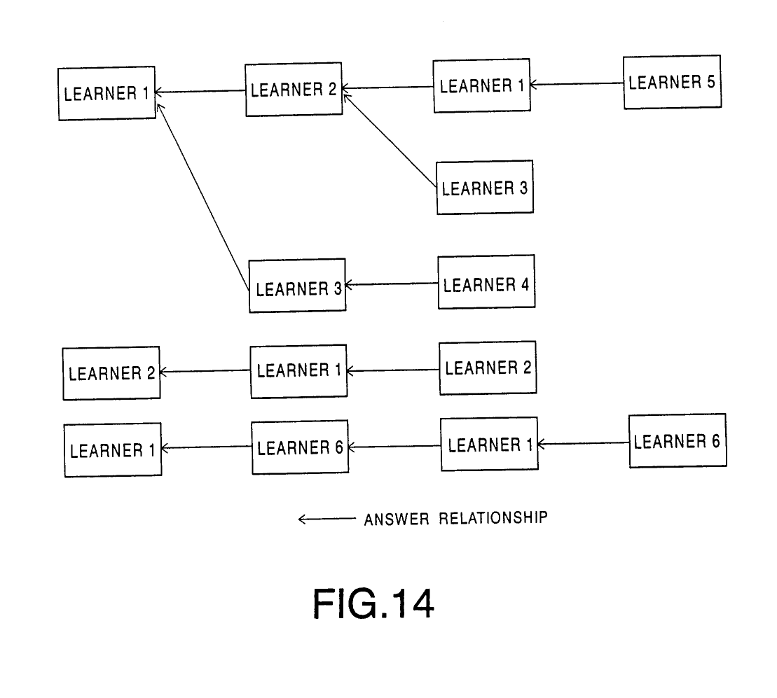

Here, in the personal relationship decision unit 21, the personal relationship between learners is decided based on the contents of the message memory 19 by the following methods. FIG. 14 is a schematic diagram of answer (reply) relationship of a message. Each rectangle in FIG. 14 represents a message and learner data as the author of the message is recorded in the rectangle. As for another learner who sent a reply to a message of a learner 1 and another learner whom the learner 1 sent a reply, the number of replies is respectively counted. A value of personal relationship is calculated for example by the following formulas.

[value of learner X's personal relationship for learner Y]=[the number of replies which learner X sent to learner Y]+[the number of replies which learner Y sent to learner X]

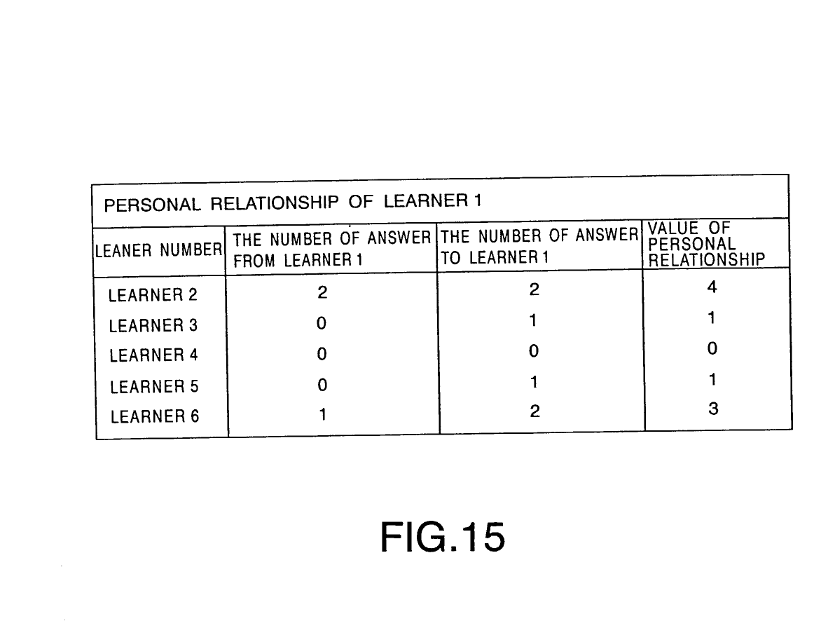

By using the above-mentioned formula, personal relationship result of the learner 1 is obtained as shown in FIG. 15.

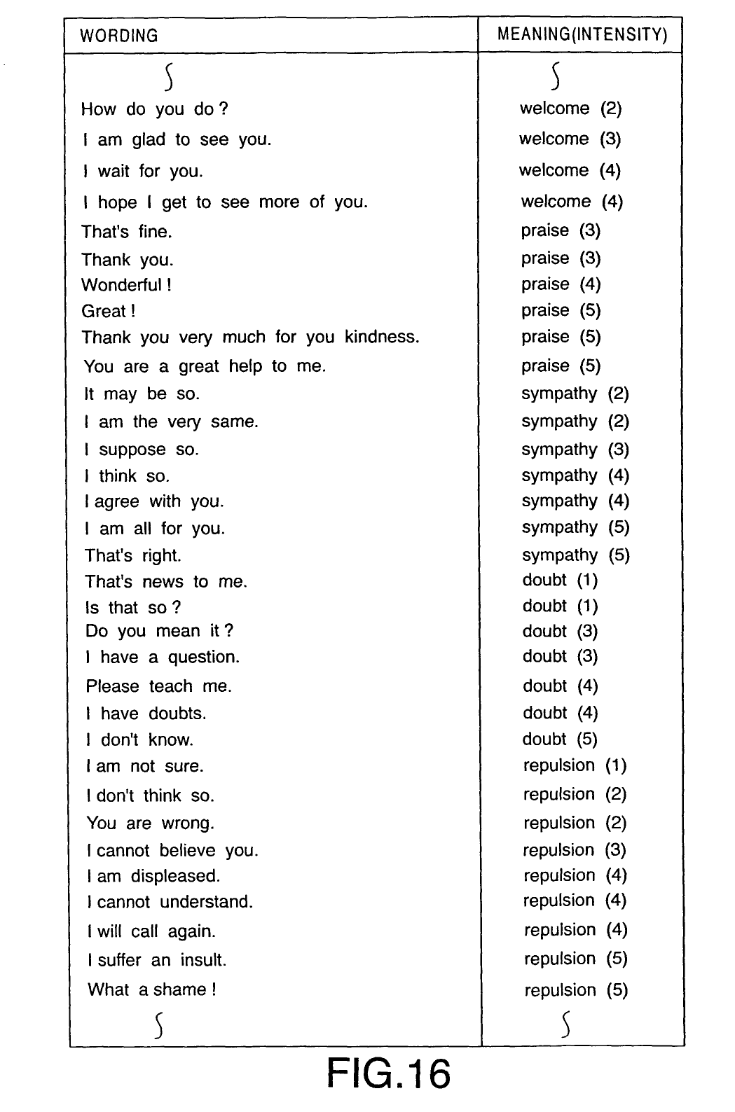

Moreover, by analyzing the text of a message, more detailed personal relationship values can be calculated. For example, a method disclosed in the Japanese patent application No.2001-86224 by the applicant of the present application can be used. In this case, by using an expression dictionary prepared beforehand, the expression is extracted from a reply message body. As for the extracted expression, meaning such as “welcome”, “praise”, “sympathy”, “question” and “repulsion”, and the intensity and frequency are determined. FIG. 16 shows an example of the expression dictionary. For example, in the case of a reply message shown in FIG. 10, expressions “how do you do?” and “I am the same.” are included. The meaning and intensity of each expression is “welcome (2)” and “sympathy (2)”. All expressions are extracted from the reply message using the expression dictionary, and the intensities of all extracted expressions are added. By using this method, a value of personal relationship can be calculated by the following formula.

[value of learner X's personal relationship for learner Y]=[the number

of replies which learner X sent to learner Y]+[the number of replies which learner Y sent to learner X]+[(the sum of intensity of “welcome”, “praise” and “sympathy” included in the reply)×0.2]−[(the sum of intensity of “doubt” and “repulsion” included in the reply)×0.2]

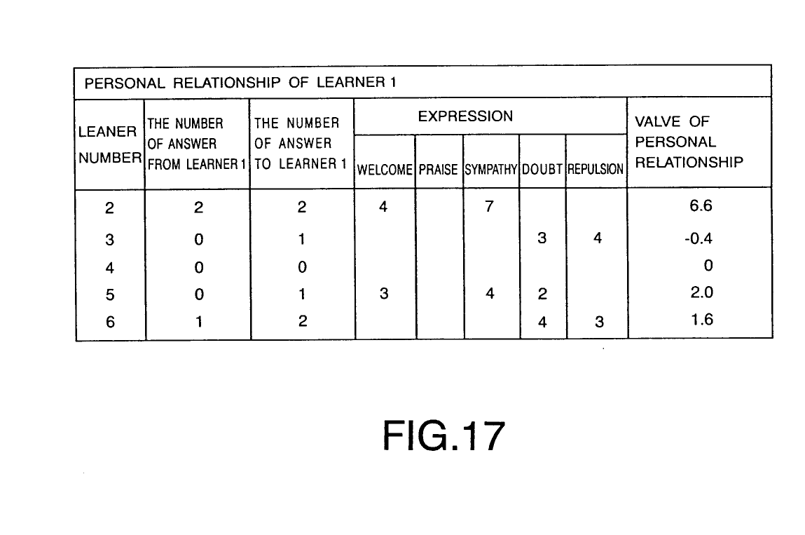

FIG. 17 shows an example of the value of personal relationship calculated by above-mentioned formula.

Thus, by combining the analysis result of the contents of a message body, if the personal relationship is good irrespective of few number of replies, the value of personal relationship can be increased. Moreover, if the contents of replies are not related to each other irrespective of a large number of replies, the value of personal relationship can be decreased. Moreover, if the expression is extracted from the reply message body except for quoted other message, the accuracy increases. Moreover, especially, the text just behind a quotation portion often includes an opinion of the original message. Therefore, the expression may be extracted only from the paragraph just behind the quotation portion. Furthermore, weight of expression extracted from the paragraph just behind the quotation portion may be strengthen.

After calculating the value of personal relationship by the above methods, by checking the learning condition of learner of high value of personal relationship, another learner who studied the same teaching material is specified. In this case, if there are many learners of positive personal relationship, priority order of learners is decided according to one of the following rules, and another learner of high priority is selected.

As a method 1 for determining learner's priority, another learner of large value of personal relationship has priority. Thereby, the learning condition of good friend can be presented preferentially.

As a method 2 for determining learner's priority, another learner of which time of the learning condition is lower than the awakening level has priority. Thereby, the learner can know the existence of a friend (another learner) who has lost motivation, and the learner can send an encouragement message to the other learner.

As a method 3 for determining learner's priority, another learner of which time of the learning condition is higher than the awakening level has priority. Thereby, the learner can know the existence of a friend (another learner) who holds out and is a good incentive for the learner, and the learner can ask the other learner a question.

As a method 4 for determining learner's priority, another learner of which transition of the learning condition is similar to the learner has priority. Thereby, a feeling of isolation of the learner is weakened, group consciousness is raised, and each learner mutually can be encouraged.

As a method 5 for determining learner's priority, another learner of which transition of the learning condition is different from the learner has priority. Thereby, the learner can find another learner who understand learning item weak for the learner, and the learner can ask the other learner a question.

As a method 6 for determining learner's priority, another learner who is isolated has priority. Thereby, other learners who have few friends avoid isolation.

In addition, a personal relationship changes with the passage of time. Therefore, the latest personal relationship may be calculated using the latest message only. Alternatively, another learner who is not familiar with the learner recently may have priority. Moreover, the learner himself may set or change the personal relationship. In this case, two persons' recognition sometimes crosses in personal relationship between the two same persons. For example, although a learner 1 thinks that a learner 2 is intimate, the learner 2 thinks that the learner 1 is not intimate. In this case, it permits that a learning condition of the learner 1 is presented to the learner 2. However, it does not permit that a learning condition of the learner 2 is presented to the learner 1. Presentation of learning condition of one direction is performrd. Alternatively, personal relationship between two learners may be determined in accordance with low value set by one of the two learners. In this case, partner's learning condition is mutually not presented between the two learners.

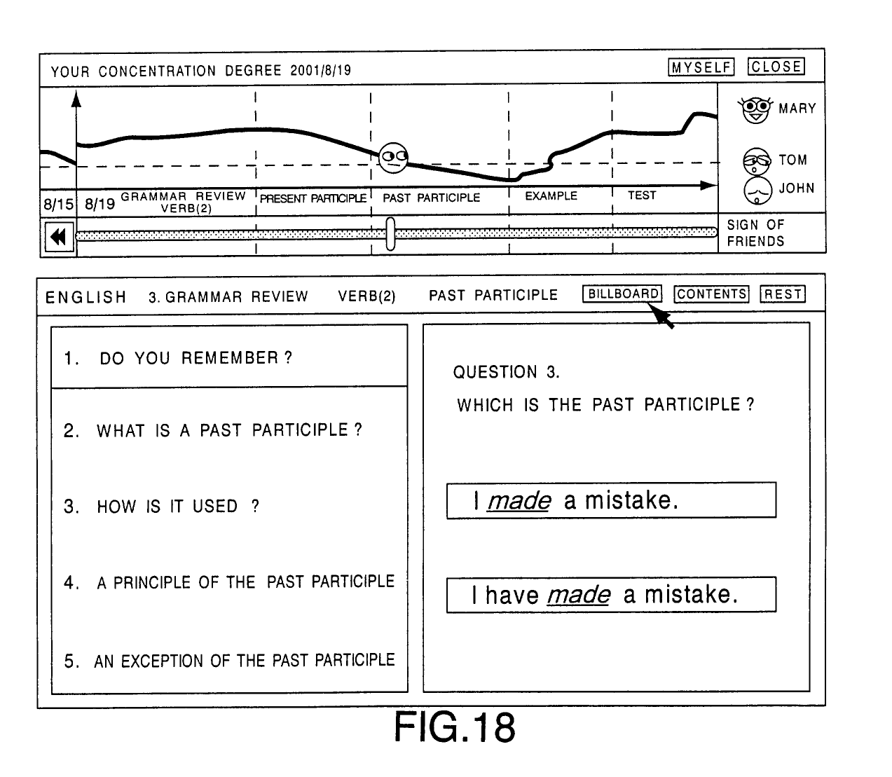

In examples of FIGS. 12 and 13, the learning condition of a friend who has learned the same teaching material was only displayed. However, a friend's latest learning condition may be displayed irrespective of the contents of teaching materials. For example, as shown in FIG. 18, the latest learning condition of friends may be always displayed. In this case, the learner can always watch his/her friend's situation. Therefore, it is effective for the learner to decrease his/her solitary feeling.

When a learner has interrupted study for a while and the latest learning condition of the learner cannot be decided, a mark which the learner has turned to back, a mark representing the learner's absence, or the last learning day, is displayed. Thereby, other learners can notice their friends' absence, and send a message such as “how are you getting along?” to the friend. Briefly, a cause of resumption of learning can be given to the friend.

According to the second embodiment of the present invention, a learner can easily understand a learning condition of another learner who is familiar with the learner. Thereby, the learning condition is a good incentive for the learner, and a feeling of isolation decreases. Moreover, each learner can see a situation of a friend of which learning volition has fallen, and each learner can send a message of encouragement to the friend. Furthermore, a learner can ask another learner who understand about study item about which the learner cannot understand. Thus, by promoting communication between learners who tend to be isolated, a learner can maintain volition and continue learning.

As mentioned-above, according to the present invention, a learner who performs independence study using the teaching material provided through a network is supported. Therefore, each learner can maintain learning volition and continue learning.

For embodiments of the present invention, the processing of the learning support apparatus of the present invention can be accomplished by computer-executable program, and this program can be realized in a computer-readable memory device.

In embodiments of the present invention, the memory device, such as a magnetic disk, floppy disk, hard disk, optical disk (CD-ROM, CD-R, DVD, and so on), optical magnetic disk (MD, and so on) can be used to store instructions for causing a processor or computer to perform the processes described above.

Furthermore, based on indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

In embodiments of the present invention, the computer executes each processing stage of the embodiments according to the program stored in the memory device. The computer may be one apparatus such as a personal computer or a system in which a plurality of processing apparatuses are connected through the network. Furthermore, in the present invention, the computer is not limited to the personal computer. Those skilled in the art will appreciate that a computer includes a processing unit in an information processor, a micro computer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A learning support apparatus, comprising:
a teaching material memory configured to store teaching material;
a teaching material presentation unit configured to present the teaching material to a learner;
an operation unit configured to input operation information from the learner corresponding to the teaching material presented by said teaching material presentation unit;
a condition information input unit configured to acquire condition information representing the learner's condition;
a learning condition decision unit configured to determine a learning condition of the learner based on the condition information acquired by said condition information input unit, the teaching material presented by said teaching material presentation unit, and the operation information inputted by said operation unit;
a learning condition memory configured to correspondingly store the learning condition and the presented teaching material as time series information;
a presentation method decision unit configured to determine a presentation method of the teaching material stored in said teaching material memory and the time series information stored in said learning condition memory based on the learning condition; and
a learning condition presentation unit configured to present the time series information stored in said learning condition memory to the learner based on the presentation method determined by said presentation method decision unit.

2. The learning support apparatus according to claim 1,
wherein the condition information includes at least one of the learner's voice information, image information, and living body information.

3. The learning support apparatus according to claim 1,
wherein said learning condition decision unit analyzes the condition information and calculates an awakening degree representing a concentration degree for the presented teaching material based on the analysis result.

4. The learning support apparatus according to claim 1,
wherein said learning condition memory stores a teaching material ID of the presented teaching material, the operation information and the learning condition in correspondence with time information and a learner ID of the learner.

5. The learning support apparatus according to claim 1,
wherein said presentation method decision unit extracts a previous learning condition of the learner ID from said learning condition memory at the time of learning start, calculates a concentration time in which the awakening degree is above an awakening level based on the previous learning condition, and calculates a ratio of the concentration time in a previous learning time.

6. The learning support apparatus according to claim 5, wherein,
if the ratio of the concentration time is above a threshold,
said presentation method decision unit presents a continuation of previous teaching materials at the previous learning time through said teaching material presentation unit.

7. The learning support apparatus according to claim 5, wherein,
if the ratio of the concentration time is not above a threshold,
said presentation method decision unit presents a graph of the previous learning condition of the learner in correspondence with the presentation situation of the previous teaching materials through said learning condition presentation unit.

8. The learning support apparatus according to claim 7,
wherein said operation unit selects whether past teaching material is presented again in response to an indication of the learner.

9. The learning support apparatus according to claim 4,
wherein said learning condition decision unit determines the learning condition when the operation information is not inputted from said operation unit during the learner's learning.

10. The learning support apparatus according to claim 9, wherein,
if the learning condition is continually above a threshold level,
said presentation method decision unit presents the same teaching material through said teaching material presentation unit.

11. The learning support apparatus according to claim 10, wherein,
if the learning condition falls from the threshold level,
said presentation method decision unit presents additional information with the teaching material through said teaching material presentation unit.

12. The learning support apparatus according to claim 9, wherein,
if the learning condition is below a threshold level,
said presentation method decision unit presents a table of contents of the teaching material through said teaching material presentation unit.

13. The learning support apparatus according to claim 12,
wherein said operation unit selects whether another teaching material is presented in response to an indication of the learner.

14. The learning support apparatus according to claim 12, wherein,
if the learning condition rises above the threshold level,
said presentation method decision unit presents a graph of the learning condition up to the present in correspondence with the presentation situation of the teaching materials through said learning condition presentation unit.

15. The learning support apparatus according to claim 14,
wherein said operation unit selects whether past teaching material is presented again in response to an indication of the learner.

16. The learning support apparatus according to claim 1, further comprising:
a message input unit configured to respectively input a message from one of a plurality of learners who learn the same teaching material;
a message memory configured to store the message;
a message presentation unit configured to present the message stored in the message memory to the learner; and
a personal relationship decision unit configured to determine a personal relationship value between the learner and another learner by referring to the message stored in said message memory;
wherein said presentation method decision unit decides whether the learning condition of another learner is presented based on the personal relationship value determined by said personal relationship decision unit.

17. The learning support apparatus according to claim 16,
wherein said operation unit selects whether the learning condition of another learner is presented in response to an indication of the learner.

18. The learning support apparatus according to claim 16,
wherein said learning condition memory respectively stores the learning condition of each of the plurality of learners in correspondence with the presentation of the teaching material.

19. The learning support apparatus according to claim 16,
wherein said presentation method decision unit acquires the learning condition of another learner from said learning support apparatus of another learner through a network.

20. The learning support apparatus according to claim 16,
wherein said personal relationship decision unit respectively calculates a personal relationship value between the leaner and each of other learners based on the sum of the number of messages sent from the learner to each of other learners and the number of messages sent from each of other learners to the learner.

21. The learning support apparatus according to claim 16,
wherein said personal relationship decision unit respectively calculates the personal relationship value between the leaner and each of other learners based on the sum of an intensity of expression included in the messages sent from the learner to each of other learners and an intensity of expressions included in the messages sent from each of other learners to the learner.

22. The learning support apparatus according to claim 20,
wherein said presentation method decision unit presents the learning condition of another learner having a personal relationship value larger than a threshold through said learning condition presentation unit.

23. The learning support apparatus according to claim 16,
wherein said presentation method decision unit presents the learning condition of another learner having a learning condition lower than a threshold level through said learning condition presentation unit.

24. The learning support apparatus according to claim 16,
wherein said presentation method decision unit presents the learning condition of another learner having a learning condition higher than a threshold level through said learning condition presentation unit.

25. The learning support apparatus according to claim 16,
wherein said presentation method decision unit presents the learning condition of another learner having a learning condition similar to the learner through said learning condition presentation unit.

26. The learning support apparatus according to claim 16,
wherein said presentation method decision unit presents the learning condition of another learner having a learning condition different from the learner through said learning condition presentation unit.

27. The learning support apparatus according to claim 16,
wherein said presentation method decision unit presents the learning condition of another learner having a few messages sent and received through said learning condition presentation unit.

28. The learning support apparatus according to claim 16,
wherein said presentation method decision unit transmits the learning condition of the learner to said learning support apparatus of another learner having a personal relationship value larger than a threshold through a network.

29. A method for supporting learning, comprising:
storing teaching material in a teaching material memory;
presenting the teaching material to a learner;
inputting operation information from the learner corresponding to the teaching material presented;
acquiring condition information representing the learner's condition;
determining a learning condition of the learner based on the condition information acquired, the teaching material presented, and the operation information inputted;
correspondingly storing the learning condition and the presented teaching material as time series information in a learning condition memory;
determining a presentation method of the teaching material stored in the teaching material memory and the time series information stored in the learning condition memory based on the learning condition; and
presenting the time series information stored in the learning condition memory to the learner based on the presentation method determined.

30. A computer program product, comprising:
a computer readable program code embodied in said product for causing a computer to support learning, said computer readable program code having:
a first program code to store teaching material in a teaching material memory;
a second program code to present the teaching material to a learner;
a third program code to input operation information from the learner corresponding to the teaching material presented;
a fourth program code to acquire condition information representing the learner's condition;
a fifth program code to determine a learning condition of the learner based on the condition information acquired, the teaching material presented, and the operation information inputted;
a sixth program code to correspondingly store the learning condition and the teaching material presented as time series information in a learning condition memory;
a seventh program code to determine a presentation method of the teaching material stored in the teaching material memory and the time series information stored in the learning condition memory based on the learning condition; and
an eighth program code to present the time series information stored in the learning condition memory to the learner based on the presentation method determined.
